(19) United States
(12) Patent Application Publication
(10) Pub. No.: US 2020/0272536 A1
(43) Pub. Date: Aug. 27, 2020

(54) METHOD OF EXECUTING INITIAL PROGRAM LOAD IN ELECTRONIC DEVICE

(71) Applicant: FARADAY TECHNOLOGY CORPORATION, Hsinchu (TW)

(72) Inventors: Shan-Tai CHEN, Hsinchu (TW); Jian-Guo CHEN, Hsinchu (TW); Chun-Yuan LAI, Hsinchu (TW)

(21) Appl. No.: 16/429,618

(22) Filed: Jun. 3, 2019

(30) Foreign Application Priority Data
Feb. 27, 2019 (TW) 108106842

(51) Int. Cl. G06F 11/10; G06F 9/4401; G06F 12/02; H04L 9/06

(52) U.S. Cl. CPC G06F 11/1004; H04L 9/0643; G06F 12/0246; G06F 9/4401

(57) ABSTRACT

A method of executing an initial program load in an electronic device is provided. The electronic device includes a chip. The chip is connected with a storage device. The method includes the following steps. First, checking data and a characteristic value are read from the storage device. Then, an algorithm parameter is acquired from the checking data. Then, the checking data and the characteristic value are verified according to a specified checking algorithm and the algorithm parameter. If a result of the specified checking algorithm passes, a boot code is executed. If the result of the specified checking algorithm fails, a notification signal is issued.

This application claims the benefit of Taiwan Patent Application No. 108106842, filed Feb. 27, 2019, the subject matter of which is incorporated herein by reference.

### FIELD OF THE INVENTION

The present invention relates to a data processing method for an electronic device, and more particularly to a method of executing an initial program load in an electronic device.

### BACKGROUND OF THE INVENTION

Generally, an electronic device has a chip. The chip is equipped with a mask read-only memory (mask ROM). An initial program load (IPL) is stored in the mask read-only memory. The initial program load is also referred as a Boot ROM.

Since the mask read-only memory is constructed in the chip, the initial program load is recorded in the mask read-only memory after the chip is manufactured. In other words, the initial program load cannot be modified after the chip is manufactured.

While the electronic device is booted, the chip executes the initial program load. The execution of the initial program load verifies the accuracy and integrity of a boot code that is stored in an external storage device (e.g., a flash memory).

After the chip confirms that the boot code in the storage device is correct, the chip executes the verified initial program load and initializes the electronic device. After the initialization of the electronic device is successful, the electronic device can be operated normally.

Generally, the chip in the electronic device is an application-specific integrated circuit chip (ASIC) chip or a system on a chip (SoC chip).

FIG. 1 schematically illustrates the operations of an initial program load and a storage device in a conventional electronic device. In a data preparation stage, the manufacturer of the electronic device provides a raw data (e.g., the boot code) to a cyclic redundancy check (CRC) generator 102. Then, the CRC generator 102 generates a checking data and a cyclic redundancy check value (also referred as CRC value) according to a CRC polynomial C(x). Then, the checking data and the CRC value generated by the CRC generator 102 are stored in a storage device 104. For example, the storage device 104 is a flash memory.

The CRC polynomial C(x) comprises plural polynomial coefficients b₃₁˜b₀. That is, after the CRC generator 102 performs a computing operation on the raw data according to the CRC polynomial C(x), the corresponding checking data and the corresponding CRC value are generated. Generally, the plural polynomial coefficients b₃₁˜b₀ in the CRC polynomial C(x) belong to parts of the initial program load. During the process of fabricating the chip 110, the polynomial coefficients b₃₁˜b₀ are stored in a mask ROM 112 of the chip 110.

After the electronic device 100 is fabricated, the electronic device 100 comprises the chip 110 and the storage device 104. While the electronic device is booted, the electronic device 100 enters a data loading stage.

In the data loading stage, the initial program load in the mask ROM 112 is executed by the chip 110. Then, the checking data and the CRC value are read from the storage device 104 under control of the initial program load.

In addition, the chip 110 establishes the CRC polynomial C(x) according to the polynomial coefficients b₃₁˜b₀ in the mask ROM 112, and performs a CRC calculation on the checking data and the CRC value according to the CRC polynomial C(x).

If the result of the CRC calculation passes, the chip 110 confirms that the content of the checking data of is valid. That is, the boot code is correct. Then, the chip 110 initializes the electronic device 100 according to the boot code. After the initialization of the electronic device 100 is successful, the electronic device 100 can be operated normally. Whereas, if the result of the CRC calculation fails, the chip 110 does not continuously initialize the electronic device 100 but issues a notification signal to prompt the user.

As mentioned above, the polynomial coefficients b₃₁˜b₀ are directly recorded in the mask ROM 112 of the chip 110. That is, after the chip 110 is fabricated, the polynomial coefficients b₃₁˜b₀ are stored in the mask ROM 112 and cannot be modified. Consequently, the CRC polynomial C(x) is a fixed polynomial. If the polynomial coefficients b₃₁˜b₀ are stolen, the CRC polynomial C(x) is cracked and the content of the storage device 106 can be modified arbitrarily.

If the manufacturer of the chip 110 intends to modify the polynomial coefficients b₃₁˜b₀ of the CRC polynomial C(x), the manufacturer has to re-design the chip 110.

### SUMMARY OF THE INVENTION

An embodiment of the present invention provides a method of executing an initial program load in an electronic device. The electronic device includes a chip. The chip is connected with a storage device. The method includes the following steps. Firstly, a checking data and a cyclic redundancy check value are read from the storage device. Then, plural polynomial coefficients are acquired from the checking data, and a cyclic redundancy check polynomial is established according to the plural polynomial coefficients. Then, a cyclic redundancy check calculation is performed on the checking data and the cyclic redundancy check value according to the cyclic redundancy check polynomial. If a result of the cyclic redundancy check calculation passes, a boot code is executed. If the result of the cyclic redundancy check calculation fails, a notification signal is issued.

Another embodiment of the present invention provides a method of executing an initial program load in an electronic device. The electronic device includes a chip. The chip is connected with a storage device. The method includes the following steps. Firstly, a checking data and a characteristic value are read from the storage device. Then, an algorithm parameter is acquired from the checking data. Then, the checking data and the characteristic value are verified according to a specified checking algorithm and the algorithm parameter. If a result of the specified checking algorithm passes, a boot code is executed. If the result of the specified checking algorithm fails, a notification signal is issued.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) schematically illustrates the operations of an initial program load and a storage device in a conventional electronic device;

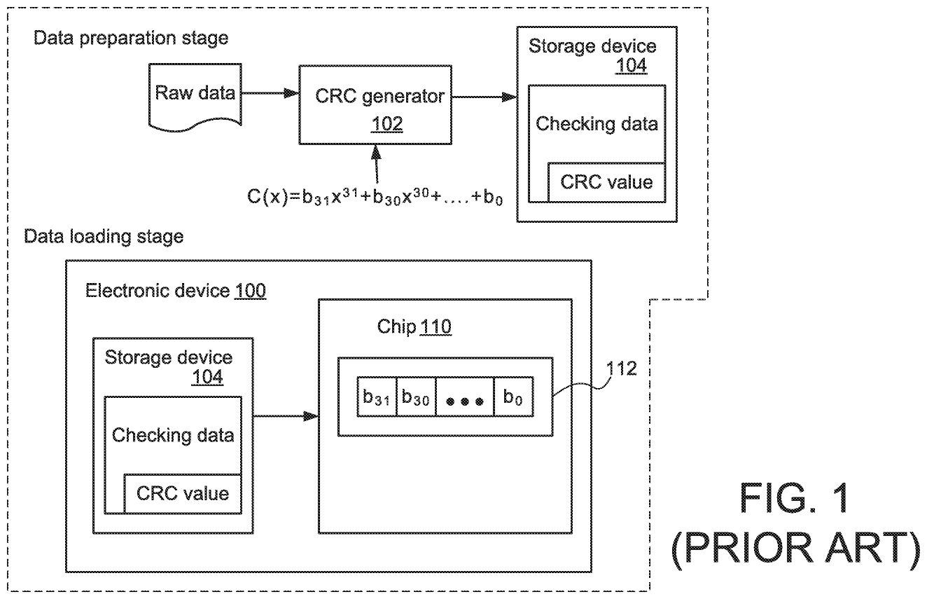

FIG. 2A schematically illustrates the operations of an initial program load and a storage device in an electronic device according to a first embodiment of the present invention;

FIG. 2B is a flowchart illustrating a method of executing an initial program load in the electronic device according to the first embodiment of the present invention; and

FIG. 3 schematically illustrates the operations of an initial program load and a storage device in an electronic device according to a second embodiment of the present invention.

### DETAILED DESCRIPTION OF PREFERRED EMBODIMENTS

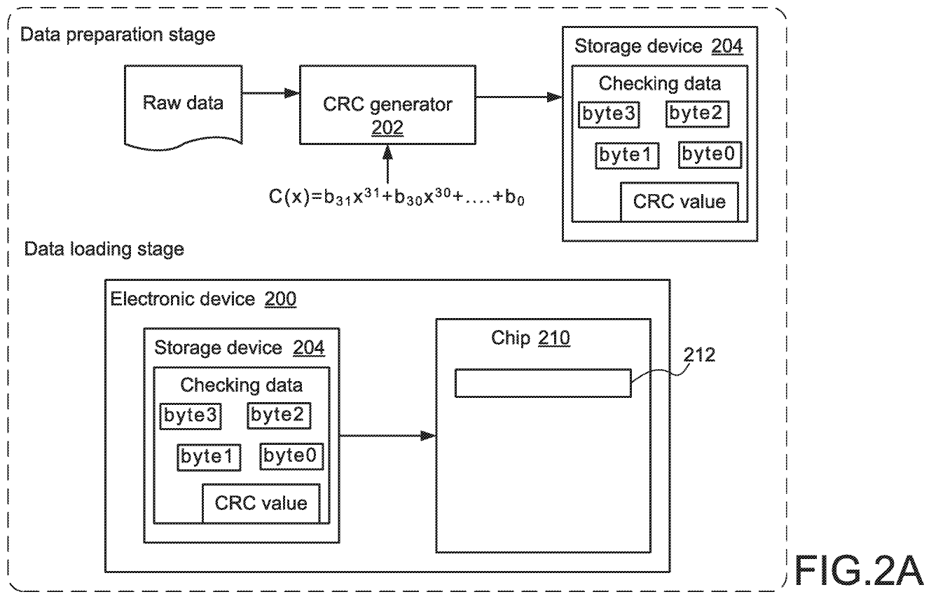

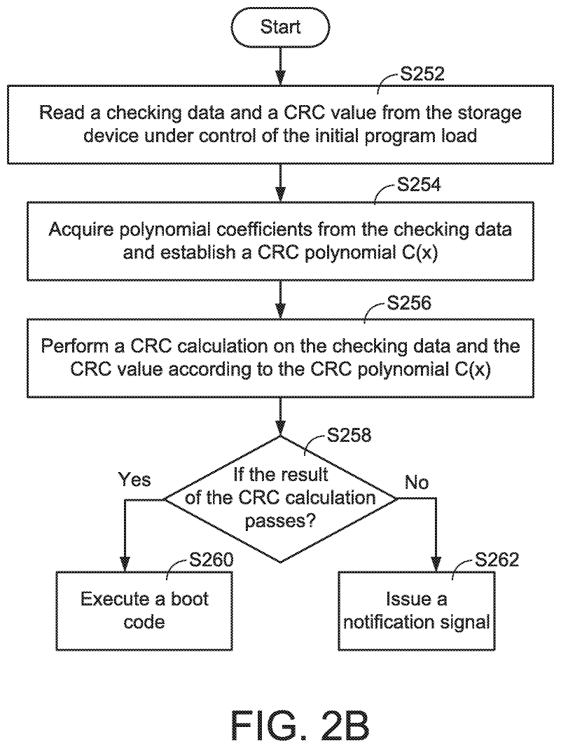

FIG. 2A schematically illustrates the operations of an initial program load and a storage device in an electronic device according to a first embodiment of the present invention. FIG. 2B is a flowchart illustrating a method of executing an initial program load in the electronic device according to the first embodiment of the present invention.

In a data preparation stage, the manufacturer of the electronic device provides a raw data (e.g., the boot code) to a cyclic redundancy check (CRC) generator 202. Then, the CRC generator 202 generates a checking data and a cyclic redundancy check value (also referred as CRC value) according to a CRC polynomial C(x). Then, the checking data and the CRC value generated by the CRC generator 202 are stored in a storage device 204. For example, the storage device 204 is a flash memory.

The CRC polynomial C(x) comprises plural polynomial coefficients b₃₁˜b₀. The polynomial coefficients b₃₁˜b₀ are stored in the storage device 204 and mixed in the checking data. As shown in FIG. 2A, the polynomial coefficients b₃₁˜b₀ are divided into four bytes byte3˜byte0. These four bytes are distributed in specified locations of the checking data and stored in the storage device 204. In other words, the plural polynomial coefficients b₃₁˜b₀ do not belong to parts of the initial program load. Consequently, during the process of fabricating the chip 210, the polynomial coefficients b₃₁˜b₀ are not stored in the mask ROM 212 of the chip 210.

While the electronic device 200 is booted, the electronic device 200 enters a data loading stage. In the data loading stage, the initial program load in the mask ROM 212 is executed by the chip 210. Then, the checking data and the CRC value are read from the storage device 204 under control of the initial program load.

Please refer to the flowchart of FIG. 2B. After the electronic device 200 is booted, the chip 210 reads the checking data and the CRC value from the storage device 204 under control of the initial program load (Step S252).

Then, the chip 210 acquires polynomial coefficients b₃₁˜b₀ from four bytes byte3˜byte0 corresponding to specified locations of the checking data and establishes a CRC polynomial C(x) according to the polynomial coefficients b₃₁˜b₀ (Step S254).

Then, the chip 210 performs a CRC calculation on the checking data and the CRC value according to the CRC polynomial C(x) (Step S256).

If the result of the CRC calculation passes (Step S258), the chip 210 confirms that the content of the checking data of is valid. That is, the boot code is correct. Then, the chip 210 executes the boot code (Step S60) to initialize the electronic device 200. After the initialization of the electronic device 200 is successful, the electronic device 200 can be operated normally. Whereas, if the result of the CRC calculation fails (Step S258), the chip 210 does not continuously initialize the electronic device 200 but issues a notification signal to prompt the user (Step S262).

In this embodiment, the polynomial coefficients b₃₁˜b₀ of the CRC polynomial C(x) are stored in the storage device 204. Consequently, the polynomial coefficients b₃₁˜b₀ of the CRC polynomial C(x) can be modified at will. That is, the CRC polynomial C(x) is not a fixed CRC polynomial. For preventing the polynomial coefficients b₃₁˜b₀ from being stolen, the polynomial coefficients b₃₁˜b₀ and the checking data are mixed together to obtain a mixed checking data. The mixed checking data is stored in the storage device 204. As mentioned above, the polynomial coefficients b₃₁˜b₀ are divided into four coefficient bytes byte3˜byte0. These four coefficient bytes byte3˜byte0 are distributed in discontinuous locations of the checking data and stored in the storage device 204.

After the electronic device 200 is powered on, the chip 210 reads the four coefficient bytes byte3˜byte0 from the specified addresses of the storage device 204 in order to acquire the polynomial coefficients b₃₁˜b₀. Consequently, the CRC polynomial C(x) is acquired. Then, the chip 210 performs the CRC calculation on the checking data and the CRC value according to the CRC polynomial C(x).

As mentioned above, the polynomial coefficients b₃₁˜b₀ of the CRC polynomial C(x) can be modified. Moreover, since the polynomial coefficients b₃₁˜b₀ and the checking data are mixed together and stored in the storage device 204, the storage addresses of the polynomial coefficients b₃₁˜b₀ in the storage device 204 cannot be easily acquired by the external device. Since the polynomial coefficients b₃₁˜b₀ are not easily stolen, the CRC polynomial C(x) is not easily cracked.

As mentioned above, the polynomial coefficients b₃₁˜b₀ of the CRC polynomial C(x) can be modified arbitrarily. In an embodiment, the polynomial coefficients b₃₁˜b₀ are generated according to a Hash function. Consequently, the complexity of cracking the polynomial coefficients b₃₁˜b₀ is increased. For example, after the contents of the four coefficient bytes of the raw data are inputted into the Hash function, the polynomial coefficients b₃₁˜b₀ in 32 bits are generated.

Moreover, the way of mixing the polynomial coefficients b₃₁˜b₀ and the checking data is not restricted. For example, in another embodiment, the four coefficient bytes byte3˜byte0 of the polynomial coefficients b₃₁˜b₀ are stored in the continuous address spaces of the checking data.

Alternatively, the four coefficient bytes byte3˜byte0 are mapped to other four mapped bytes through a look-up table. Then, the four coefficient bytes byte3˜byte0 are mixed in the checking data. After the electronic device 200 is powered on, the chip 210 acquires the four coefficient bytes byte3˜byte0 and converts the four coefficient bytes byte3˜byte0 into the four mapped bytes according to the look-up table. Consequently, the polynomial coefficients b₃₁˜b₀ are obtained, and the CRC polynomial C(x) is confirmed.

In addition to the cyclic redundancy check process, other checking processes may be employed to achieve the purpose of the present invention.

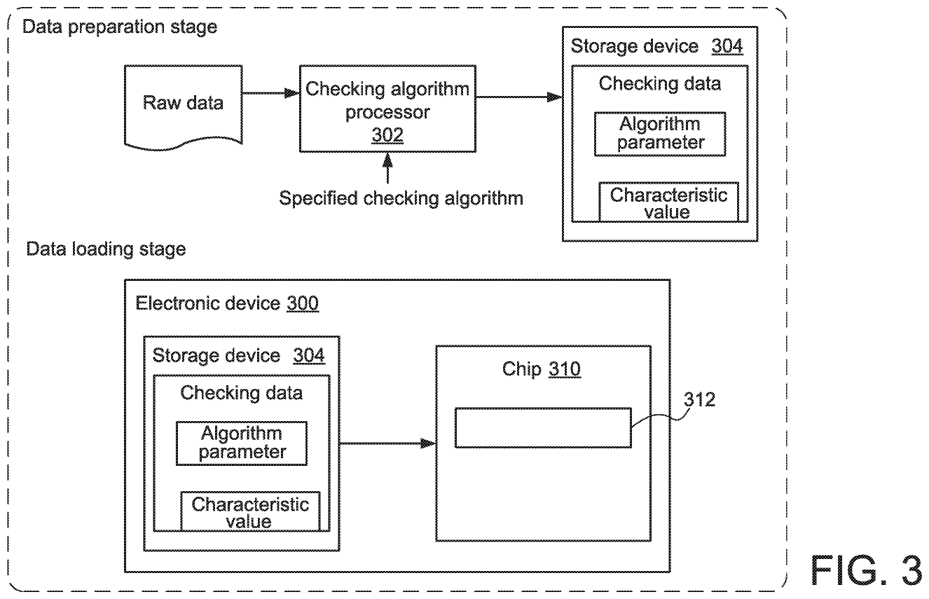

FIG. 3 schematically illustrates the operations of an initial program load and a storage device in an electronic device according to a second embodiment of the present invention. While the electronic device 300 executes an initial program load and reads the data from the storage device 304, a specified checking algorithm is performed to verify the accuracy and integrity of the data in the storage device 304. For example, the specified checking algorithm is an encryption algorithm or a cyclic redundancy check algorithm.

In a data preparation stage, the manufacturer of the electronic device provides a raw data (e.g., the boot code) to a checking algorithm processor 302. Then, the checking algorithm processor 302 generates a checking data and a characteristic value according to the specified checking algorithm. Then, the checking data and the characteristic value are stored in the storage device 304. For example, the storage device 304 is a flash memory. Moreover, the specified checking algorithm is included in the initial program load and recorded in the mask ROM 312.

In an embodiment, an algorithm parameter of the specified checking algorithm is also stored in the storage device 304 and mixed in the checking data. In case that the specified checking algorithm is an encryption algorithm, the algorithm parameter is a key for the encryption algorithm. In case that the specified checking algorithm is a cyclic redundancy check algorithm, the algorithm parameter includes the polynomial coefficients b₃₁˜b₀ of the CRC polynomial C(x).

While the electronic device 300 is booted, the electronic device 300 enters a data loading stage. In the data loading stage, the initial program load in the mask ROM 312 is executed by the chip 310. Then, the checking data, the algorithm parameter and the characteristic value are read from the storage device 304 under control of the initial program load.

After the electronic device 300 is powered on, the chip 310 reads the checking data and the characteristic value from the storage device 304. Then, the chip 310 acquires the algorithm parameter from a specified location of the checking data in order to confirm the specified checking algorithm.

Then, the chip 310 verifies the checking data and the characteristic value according to the algorithm parameter.

If the result of the specified checking algorithm passes, the chip 310 confirms that the content of the checking data of is valid. That is, the boot code is correct. Then, the chip 310 executes the boot code to initialize the electronic device 300. After the initialization of the electronic device 300 is successful, the electronic device 300 can be operated normally. Whereas, if the result of the specified checking algorithm fails, the chip 310 does not continuously initialize the electronic device 300 but issues a notification signal to prompt the user.

In the embodiment of FIG. 3, the specified checking algorithm is included in the initial program load and recorded in the mask ROM 312. It is noted that numerous modifications and alterations may be made while retaining the teachings of the invention.

For example, in another embodiment, the encryption algorithm is not included in the initial program load. Under this circumstance, the algorithm parameter (e.g., a key) for the encryption algorithm is mixed in the checking data by the checking algorithm processor 302. Consequently, the mixed checking data contains the algorithm parameter and the characteristic value. Then, the mixed checking data is stored in the storage device 304.

While the electronic device 300 is booted, the electronic device 300 enters a data loading stage. In the data loading stage, the initial program load in the mask ROM 312 is executed by the chip 310. Then, the checking data, the encryption algorithm, the algorithm parameter (e.g., a key) and the characteristic value are read from the storage device 304 under control of the initial program load. Then, the chip 310 verifies the checking data and the characteristic value according to the encryption algorithm and the algorithm parameter (e.g., the key).

From the above descriptions, the present invention provides a method of executing an initial program load in an electronic device. The specified checking algorithm is employed to protect the raw data. The algorithm parameter and the checking data are mixed together. Then, the characteristic value and the mixed checking data are stored into the storage device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A method of executing an initial program load in an electronic device, the electronic device comprising a chip, the chip being connected with a storage device, the method comprising steps of:
reading a checking data and a cyclic redundancy check value from the storage device;
acquiring plural polynomial coefficients from the checking data stored in the storage device, and establishing a cyclic redundancy check polynomial according to the plural polynomial coefficients, wherein the plural polynomial coefficients are mixed in discontinuous address spaces of the checking data;
performing a cyclic redundancy check calculation on the checking data and the cyclic redundancy check value according to the cyclic redundancy check polynomial;
if a result of the cyclic redundancy check calculation passes, executing a boot code; and
if the result of the cyclic redundancy check calculation fails, issuing a notification signal.

2. The method as claimed in claim 1, further comprising a data preparation stage, wherein the data preparation stage comprises steps of:
providing a raw data to a cyclic redundancy check generator;
the cyclic redundancy check generator converting the raw data into the checking data and the cyclic redundancy check value according to the cyclic redundancy check polynomial;
mixing the plural polynomial coefficients of the cyclic redundancy check polynomial in the checking data so as to obtain a mixed checking data; and
recording the mixed checking data and the cyclic redundancy check value into the storage device.

3. The method as claimed in claim 1, wherein the storage device is a flash memory.

4. (canceled)

5. The method as claimed in claim 1, wherein the plural polynomial coefficients are generated according to a Hash function.

6. A method of executing an initial program load in an electronic device, the electronic device comprising a chip, the chip being connected with a storage device, the method comprising steps of:
reading a checking data and a characteristic value from the storage device;
acquiring an algorithm parameter from the checking data stored in the storage device, wherein the algorithm parameter is mixed in discontinuous address spaces of the checking data;
verifying the checking data and the characteristic value according to a specified checking algorithm and the algorithm parameter;
if a result of the specified checking algorithm passes, executing a boot code; and
if the result of the specified checking algorithm fails, issuing a notification signal.

7. The method as claimed in claim 6, further comprising a data preparation stage, wherein the data preparation stage comprises steps of:
providing a raw data to a checking algorithm processor;
the checking algorithm processor converting the raw data into the checking data and the characteristic value according to the specified checking algorithm;
mixing the algorithm parameter in the checking data so as to obtain a mixed checking data; and
recording the mixed checking data and the characteristic value into the storage device.

8. The method as claimed in claim 6, further comprising a data preparation stage, wherein the data preparation stage comprises steps of:
providing a raw data to a checking algorithm processor;
the checking algorithm processor converting the raw data into the checking data and the characteristic value according to the specified checking algorithm;
mixing the specified checking algorithm and the algorithm parameter in the checking data so as to obtain a mixed checking data; and
recording the mixed checking data and the characteristic value into the storage device.

9. The method as claimed in claim 6, wherein the storage device is a flash memory.

10. The method as claimed in claim 6, wherein the specified checking algorithm is an encryption algorithm, and the algorithm parameter is a key.

11. The method as claimed in claim 6, wherein the specified checking algorithm is a cyclic redundancy check algorithm, and the algorithm parameter includes plural polynomial coefficients of a cyclic redundancy check polynomial.
